(19) United States
(12) Patent Application Publication
(10) Pub. No.: US 2009/0119292 A1
(43) Pub. Date: May 7, 2009

(54) PEER TO PEER TRAFFIC CONTROL METHOD AND SYSTEM

(75) Inventor: FLEMING SHI, CUPERTINO, CA (US)

Correspondence Address: PATENTRY, P.O. BOX 151616, SAN RAFAEL, CA, 94915-1616, US

(73) Assignee: BARRACUDA INC., CAMPBELL, CA (US)

(21) Appl. No.: 11/935,952

(22) Filed: Nov. 6, 2007

(51) Int. Cl. G06F 17/30

(52) U.S. Cl. 707/6; 707/E17.009

(57) ABSTRACT

A system, apparatus, and method for controlling peer to peer traffic at a network gateway or server. Suspected peer to peer traffic is identified heuristically and collected for content analysis. Content digital fingerprint pattern matching software is received from a remote server. Peer to peer traffic is selectively disposed of.

### BACKGROUND

Peer to peer applications are frequently considered unwelcome guests in a network because they consume bandwidth. Network administrators have an obligation to protect and manage their resources as well as to avoid liability for piracy or other damage to intellectual property rights such as copyright. In addition to security concerns, peer to peer applications have the potential to degrade quality of service for all users in a network.

Conventional firewalls are used to prevent network intrusion and the inward movement of malware. They are poorly architected to control the proliferation of peer to peer applications. Conventional firewalls may be used to block selected ports. They may also be used to block specific IP addresses or ranges of addresses. In practice they also depend on the receipt of black lists of IP addresses or ports to identify a server having an application which is objectionable.

It is a characteristic of peer to peer applications that they are designed to circumvent fixed barriers such as firewalls. There are no limit to the number of servers employed for peer to peer applications so a list of IP addresses would be ineffective. And ports may be pseudo-randomly selected from a large number so blocking a specific port would not prevent a peer to peer application. And peer to peer applications quickly proliferate among many sources which would make compiling a list of IP addresses futile.

Thus it can be appreciated that what is needed is a more flexible system to control traffic which adapts to the specific peer to peer traffic found in a local area network, which identifies potential sources of peer to peer traffic, which efficiently identifies certain peer to peer applications, and which disposes efficiently with packets suspected to contain peer to peer content.

### SUMMARY OF THE INVENTION

The present invention is a system and apparatus which comprises a processor and computer readable media tangibly embodying the following method. The present invention is a method comprising reading destination ports and IP addresses on packets, matching digital fingerprint patterns on packets with those associated with peer to peer traffic, and disposing of packets which appear to have content, destination ports, and destination IP addresses consistent with peer to peer application traffic.

### BRIEF DESCRIPTION OF DRAWINGS

FIG. 1 is a flowchart illustrating the core method of the invention.

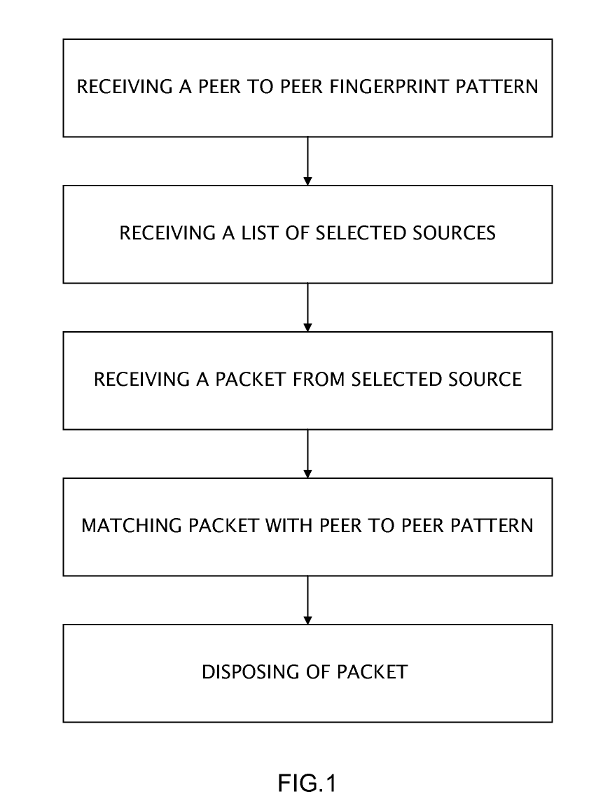

FIG. 2 is a flowchart illustrating further steps for optimization.

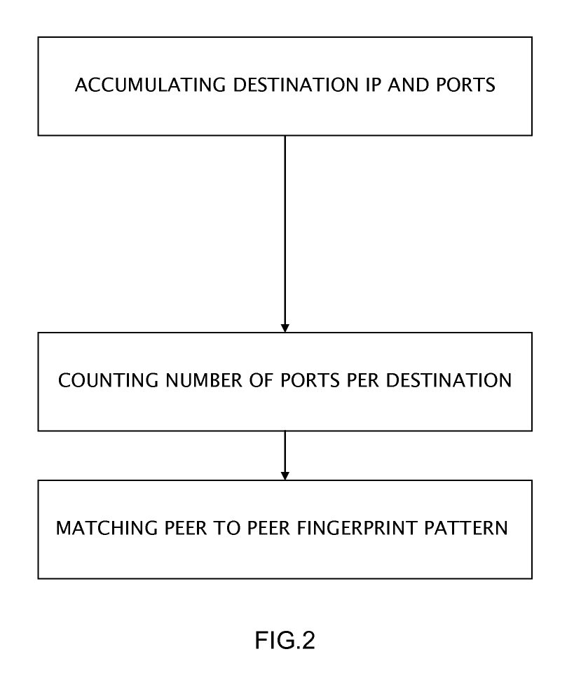

FIG. 3 is a flowchart illustrating alternate steps for optimization.

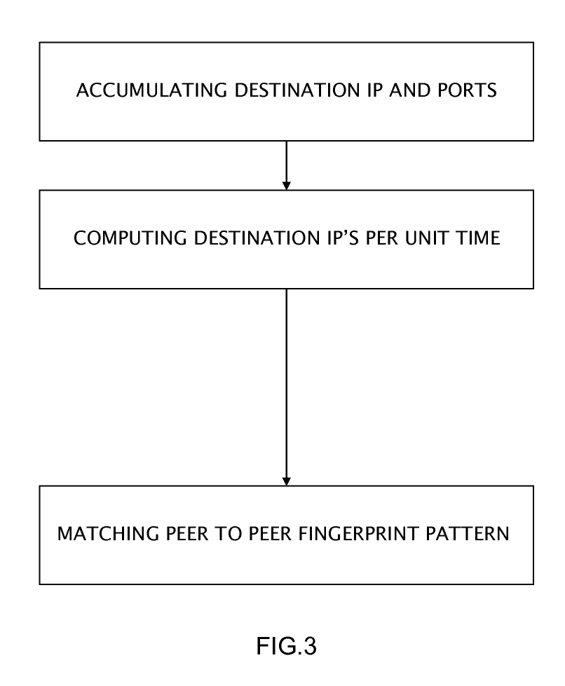

FIG. 4 is a flowchart illustrating combined optimization steps.

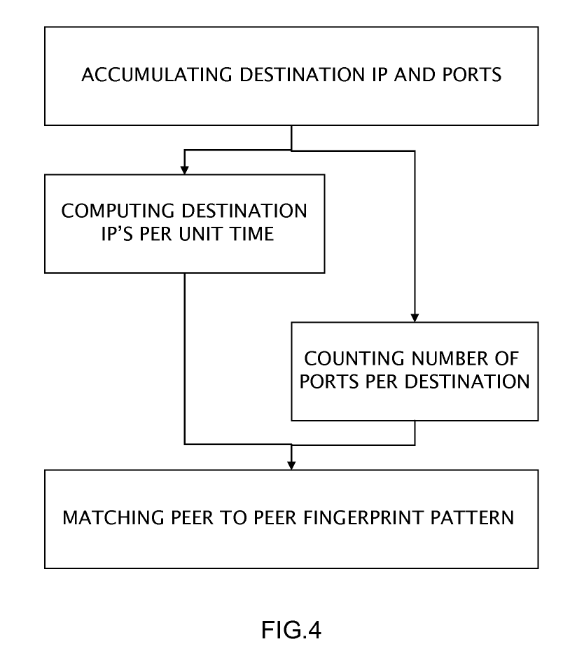

FIG. 5 is a flowchart illustrating the best mode of optimization.

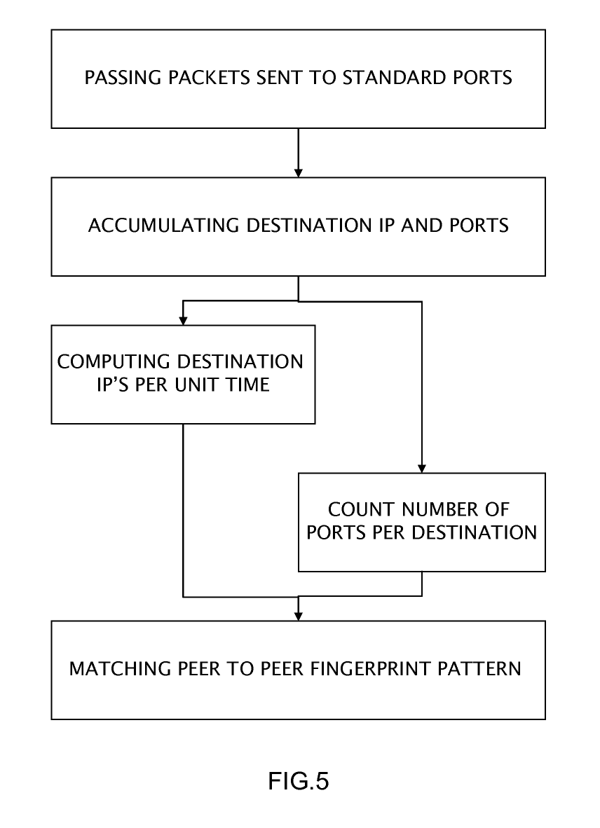

### DETAILED DISCLOSURE

To be effective, a large number of packets must be handled efficiently to avoid congestion at a gateway. The first method of the present invention is to accumulate information by reading the source and destination information of outgoing packets. Source nodes within the local area network which are sending to rapidly varying destinations are identified for further analysis. For selected IP addresses, the invention stores and compares destination ports. Some destination ports are well known for standard protocols. The nature of client server applications is that ports are stable and within a limited range. To avoid collision with these applications, peer to peer applications select from a higher range of ports. To avoid being blocked by a firewall, peer to peer applications apparently change their ports randomly and frequently. The present invention observes destination ports and selects packets that come from nodes which are sending to many IP addresses or to many ports.

For packets which have been selected according to their source and destination IP addresses and ports, further analysis is performed. In an embodiment, the analysis is embedded within a plug-in installed in the operating system of the gateway or content filter. In another embodiment, the analysis is an application module in the user space of a gateway or of a content filter. The analysis can be at least one of a digital signature, a hash, a checksum, or some other quickly computed value which serves as a fingerprint which triggers disposal.

Packets which are associated with a certain peer to peer application can be disposed of according to a policy customized for the network. Certain departments, groups, or individuals may be enabled or disabled for certain peer to peer applications. Packets may be dropped, rejected, redirected, or forwarded according to content, source, or destination.

The present invention is a method comprising the steps of
receiving and storing at least one peer to peer fingerprint pattern;
receiving a list of selected sources;
receiving a packet from a selected source;
matching a packet with a peer to peer fingerprint pattern; and
disposing of the packet according to a peer to peer service policy.

To optimize the performance of the present invention, the method further comprises a preliminary process for selecting a source of peer to peer application traffic comprising
scanning all packets transmitted from a source within a first network to a destination within a second network;
recording destination IP address and port number for each source; and
if the number of ports per destination IP exceeds a certain threshold,
matching a packet with a peer to peer fingerprint pattern.

Another optimization method for reducing the effort of selecting a source of peer to peer application traffic comprises the steps of:
scanning all packets transmitted from a source within a first network to a destination within a second network;
recording destination IP address and port number for each source; and
if the number of destination IP per unit time the source sends to exceeds a certain threshold,
matching a packet with a peer to peer fingerprint pattern.

The best mode at the time of this application is to combine both of the above as follows;
scanning all packets transmitted from a source within a first network to a destination within a second network;
computing the number of destination IP per unit time the source sends to;
recording destination IP address and port number for each source; and
if at least one of the number of ports per destination IP exceeds a first threshold, and the number of destination IP per unit time the source send to exceeds a second threshold,
matching a packet with a peer to peer fingerprint pattern.

A further optimization is adding the step of passing packets sent to standard ports associated with documented client server applications without further examination of destination IP addresses. This escapes the accumulation and analysis and pattern match.

In an embodiment a peer to peer fingerprint pattern is tangibly embodied as an executable module adapted to control a processor at the kernel level of access returning a match or no-match with a certain peer to peer application.

The present invention is a system and method for controlling peer to peer traffic comprised of
a gateway attaching a first network to a second network or a cache server in a first network relaying packets to a second network;
means for reading port and IP addresses on a packet traversing the gateway;
means for receiving peer to peer fingerprint patterns;
means for disposing of packets; and
means for matching peer to peer fingerprint patterns.

Server client applications such as email, use stable ports on widely recognized IP addresses. These are frequently documented in the RFC used in the Internet community. Peer to peer applications seek to avoid being blocked by conventional firewalls by randomly picking unused ports. By their nature some peer to peer applications attach many destinations to a source and many sources to a destination.

The method for disposing of peer to peer packet traffic can be selected from any of the following: dropping the packet, rejecting the packet, redirecting the packet, recording the packet, or forwarding the packet. The disposition of packets may vary according to the specific peer to peer application or may be allowed for certain nodes and denied to other nodes. The invention further comprises reading a local policy which allows specific peer to peer applications for certain sources.

To simplify installation and configuration of the invention, it can be provided as an appliance, an integrated turnkey hardware product having plug and play characteristics. In one embodiment the invention is a content analysis apparatus to which packets are directed by a router. In another embodiment the invention is a gateway which observes outbound packets originating from source nodes within the local area network and destined for nodes outside of the local area network.

The present invention is distinguished from conventional firewalls which rely on a static blacklist of ports or ip addresses which represent nodes known to host objectionable content. It is the nature of some peer to peer applications to have pseudo-randomly selected ports which will seldom be repeated. The present invention is distinguished by its method for identifying potential sources of peer to peer traffic. The present invention is distinguished by its steps of receiving a digital fingerprint and matching outgoing packets with the digital fingerprint which characterizes a peer to peer application.

### CONCLUSION

This invention addresses a problem facing network administrators who are responsible for content distributed from their resources to the Internet. Furthermore they must manage their enterprise resources to achieve high quality of service for their own internal customers. With a limited budget for network access bandwidth to the Internet, uncontrolled peer to peer applications could result in network congestion much earlier than expected or budgeted.

By installing a peer to peer application gateway or cache attaching a first network to a second network, an administrator obtains a processor adapted to reading port and IP addresses on a packet traversing the gateway; receiving updates to a plurality of peer to peer fingerprint patterns; analyzing a packet for a peer to peer fingerprint pattern; disposing of packets; and heuristically identifying suspect traffic for deeper analysis. The processor is adapted by a program product tangibly embodied as executable instructions recorded on computer readable media which may be automatically updated to recognize digital signatures associated with peer to peer content. The processor is adapted to read destination ports of packets and compare them with standard client server application ports. The processor is adapted to record destination IP addresses and identify packets sent by nodes to destination IP addresses and destination ports with a behavior characteristic of peer to peer applications.

The scope of the invention includes all modification, design variations, combinations, and equivalents that would be apparent to persons skilled in the art, and the preceding description of the invention and its preferred embodiments is not to be construed as exclusive of such.

What is claimed is:

1. A method comprising the steps of
receiving and storing at least one peer to peer fingerprint pattern;
matching a packet with a peer to peer fingerprint pattern; and
disposing of the packet according to a peer to peer service policy.

2. The method of claim 1 further comprising the process of receiving a list of selected sources.

3. The method of claim 2 further comprising the process
for selecting a source of peer to peer application traffic comprising
scanning all packets transmitted from a source within a first network to a destination within a second network;
recording destination IP address and port number for each source; and
if the number of ports per destination IP exceeds a certain threshold,
matching a packet with a peer to peer fingerprint pattern.

4. The method of claim 2 further comprising the process for selecting a source of peer to peer application traffic comprising
scanning all packets transmitted from a source within a first network to a destination within a second network;
recording destination IP address and port number for each source; and
if the number of destination IP per unit time the source sends to exceeds a certain threshold,
matching a packet with a peer to peer fingerprint pattern.

5. The method of claim 2 further comprising the process for selecting a source of peer to peer application traffic comprising
scanning all packets transmitted from a source within a first network to a destination within a second network;
computing the number of destination IP per unit time the source sends to;
recording destination IP address and port number for each source; and
if at least one of the number of ports per destination IP exceeds a first threshold, and
the number of destination IP per unit time the source send to exceeds a second threshold, matching a packet with a peer to peer fingerprint pattern.

6. The method of claim 5 further comprising the step of passing packets sent to standard ports associated with documented client server applications without further examination of destination IP addresses.

7. The method of claim 1 wherein a peer to peer fingerprint pattern is tangibly embodied as an executable module adapted to control a processor at the kernel level of access returning a match or no-match with a certain peer to peer application.

8. The method of claim 1 wherein a peer to peer fingerprint pattern is tangibly embodied as an executable module adapted to control a processor at the user level of access returning a match or no-match with a certain peer to peer application.

9. A system and method for controlling peer to peer traffic at a network gateway is comprised of
means for reading port and IP addresses on a packet traversing the gateway;
means for receiving at least one peer to peer fingerprint pattern;
means for receiving a list of selected sources within the first network;
means for disposing of packets; and
means for matching a packet with a peer to peer fingerprint pattern.

10. The method of claim 9 wherein disposing of peer to peer packet traffic comprises dropping the packet.

11. The method of claim 9 wherein disposing of peer to peer packet traffic comprises rejecting the packet.

12. The method of claim 9 wherein disposing of peer to peer packet traffic comprises redirecting the packet.

13. The method of claim 9 wherein disposing of peer to peer packet traffic comprises recording the packet.

14. The method of claim 9 wherein disposing of peer to peer packet traffic comprises forwarding the packet.

15. The method of claim 9 wherein selected peer to peer traffic is transmitted for a certain source.

16. The system of claim 9 wherein the means comprise a processor in a gateway attaching a first network to a second network.

17. The system of claim 9 wherein the means comprise a processor in a cache server within a first network redirecting packets to a second network.

18. A process for selecting a source of potential peer to peer application traffic for further analysis comprising
scanning all packets transmitted from a source within a first network to at least one destination within a second network;
recording destination IP address and port number for a source; and
if the number of ports per destination IP exceeds a certain threshold,
adding the source to a list of potential peer to peer application sources.

19. The process of claim 18 further comprising the step of matching a packet with a peer to peer fingerprint pattern.

20. A process for selecting a source of potential peer to peer application traffic for further analysis comprising
scanning all packets transmitted from a source within a first network to a destination within a second network;
recording destination IP address and port number for a source; and
if the number of destination IP per unit time the source sends to exceeds a certain threshold, adding the source to a list of potential peer to peer application sources.

21. The process of claim 20 further comprising the step of matching a packet with a peer to peer fingerprint pattern.

22. A process for selecting a source of potential peer to peer application traffic for further analysis comprising
scanning all packets transmitted from a source within a first network to a destination within a second network;
matching a packet with a peer to peer fingerprint pattern; and if a packet matches a peer to peer fingerprint pattern, adding the source to a list of potential peer to peer application sources.
